(19) United States
(12) Patent Application Publication
(10) Pub. No.: US 2009/0079317 A1
(43) Pub. Date: Mar. 26, 2009

(54) Electric Lamp Comprising Holding Knobs for the Luminous Element

(76) Inventors: Rupert Goihl, Steinsdorf (DE); Roland Stark, Wellheim (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/991,869

(22) PCT Filed: Sep. 20, 2006
(86) PCT No.: PCT/EP2006/066557

§ 371 Date: Mar. 11, 2008

(30) Foreign Application Priority Data
Sep. 23, 2005 (DE) 10 2005 045 644.8

(51) Int. Cl. H01K 1/50; H01K 1/14; H01J 5/00; H01K 1/28

(52) U.S. Cl. 313/113; 313/315; 313/579; 313/317

(57) ABSTRACT

The invention relates to a lamp (1), particularly a mains-operated halogen lamp, comprising a luminous element (8) that is fixed at least at one mounting point by means of exactly one funnel-shaped recess, i.e. a knob (10a-10d), which is formed from the lamp vessel (2). Each knob (10a-10d) extends substantially perpendicular to the longitudinal axis (L) of the lamp (1).

### TECHNICAL FIELD

The invention relates to an electric lamp, in particular a halogen incandescent lamp, with holding knobs for the luminous element.

With this type of lamps, the luminous element is held by means of funnel-like turned-in portions of the lamp vessel. For reasons of simplicity, these turned-in portions are also referred to as knobs below.

### PRIOR ART

Such a lamp is known, for example, from the document DE 40 08 367 A1. Said document discloses a halogen incandescent lamp with a pinch seal at one end whose elongate luminous element extends in the direction of the lamp longitudinal axis and is held there at least one point by in each case two mutually opposite knobs, which are shaped in the form of funnels from the lamp vessel material. For this purpose, the knobs are oriented at right angles with respect to the lamp longitudinal axis. In one exemplary embodiment, the halogen incandescent lamp with a pinch seal at one end is installed in an outer bulb using an Edison screw-type base, for direct operation on the system voltage.

The document DE 101 46 877 A1 discloses a reflector lamp with a halogen incandescent lamp using knob technology in accordance with the previously mentioned DE 40 08 367 A1. For this purpose, the halogen incandescent lamp is installed in a reflector coaxially with respect to the reflector axis. The reflector lamp is provided for axial light emission.

The document DE 195 28 686 A1 has disclosed a halogen incandescent lamp whose elongate luminous element is held at least one point by at least three radially oriented knobs in the lamp vessel. The axial centering of the luminous element is intended to be improved with the aid of the at least three knobs per holding point. The document discloses both lamps with a pinch seal at one end and double-ended lamps with a pinch seal at both ends.

### DESCRIPTION OF THE INVENTION

The object of the present invention is to simplify the knob technology for electric lamps and to extend the use and application possibilities for electric lamps with knob technology.

This object is achieved by an electric lamp with a lamp vessel,
at least one lamp base, which adjoins one end of the lamp vessel and by means of which a lamp longitudinal axis is defined,
at least one knob, which is formed by a turned-in portion of the lamp vessel and extends substantially at right angles with respect to the lamp longitudinal axis,
a luminous element, which is located within the lamp vessel,
   characterized in that
the luminous element is held at least one holding point by precisely one knob.

Particularly advantageous configurations are given in the dependent claims.

The knobs as such are in the form of funnel-shaped turned-in portions of the lamp vessel, as is already known from the prior art cited at the outset. The cross section of the turned-in portions can be circular, oval or else elongate, for example.

Until now it has been assumed that two or more knobs per holding point are required for luminous elements which are arranged in an imaginary plane parallel to the lamp longitudinal axis or axially; see the documents mentioned at the outset DE 40 08 367 A1 and DE 195 28 686 A1, respectively.

In contrast to the prior art, the luminous element according to the invention is only held by means of precisely one knob per holding point, however, also referred to below as single-knob holding for short. Consequently, the lamp according to the invention has fewer knobs in comparison with the prior art given the same number of holding points. As a result, a larger proportion of the lamp, vessel is free of knobs which are disruptive per se for unimpeded light emission. In particular, the single-knob holding system according to the invention makes it possible to provide the part of the lamp vessel which has no knobs with an optical layer, for example a reflective layer, and thus to also use it for targeted light guidance. In this way, under certain circumstances it is possible to dispense with an additional external reflector.

In the case of a tubular double-ended lamp, depending on the lamp length two or more holding points are provided for the luminous element, for example. Preferably, the knobs, according to the invention in each case one knob for each holding point, are now all arranged on one side along the tubular lamp vessel, for example along an imaginary line on the outside of the lamp vessel. As a result, the opposite side of the lamp vessel can be metallized with a reflective layer, for example, in order to achieve directional emission, for example for the purpose of illuminating display cabinets, furniture cabinets etc. In the case of lamps using knob technology to date, a separate reflector has been required for this.

In principle various possibilities can be considered for implementing the single-knob holding system according to the invention for the luminous element, for example an incandescent filament.

A first possibility consists in embedding a section of the incandescent filament in the tip of a knob. For this purpose, the incandescent filament is first introduced into the lamp vessel with the aid of a filament support. Then, for example, one section of the incandescent filament is pulled apart, for example by means of being heated b means of a laser beam, to such an extent that glass can enter the turns of this incandescent filament section during the subsequent knob-formation process. For the actual knob-formation process, the lamp vessel is then heated locally and pressed in as far as said incandescent filament section by means of a mandrel, for example, which is preferably itself heated. The filament support in this case also acts as an opposing bearing. Alternatively, given suitable flame guidance the knob formation process can also be carried out completely without a mandrel. The knob formation process in this case takes place merely by means of a gas flame, which is adjusted to suitable parameters such as temperature, gas throughput and focusing.

In accordance with an alternative possibility for the single-knob holding system, the incandescent filament is provided, in the region of the holding point provided, with an auxiliary turn, which surrounds the tip of the knob. In this way, the incandescent filament is held firmly on the relevant knob, in particular when the material of the knob is at least still a touch too “soft” during the fixing of the auxiliary turn.

A further possibility in particular relates to the case in which the incandescent filament is not arranged linearly but in one plane within the lamp vessel, in the manner of a polygon which is open on the side of the two power supply lines. In this case, it is also possible for the connecting sections of the filament segments of the incandescent filament to be passed around the knobs on the outside under strain and, as a result, to tenter the incandescent filament equally via the knobs. It can possibly also be helpful to orientate the individual knobs in addition such that they are slightly tilted counter to the respective direction of strain in order to avoid a situation in which the incandescent filament slips off from the knobs.

As a result of the previously explained concept according to the invention, the invention is particularly also suitable for high-volt (HV) halogen incandescent lamps, which can be operated directly on the system voltage. The number of knobs which are typically required depends on the length of the filament or on the number of the filament segments to be illuminated during lamp operation. Preferably, in each case one knob can be provided in each case between two adjacent filament segments. If the number of filament segments is N, then the number of knobs is consequently N−1. In the case of lamps with a base at one end, in addition in each case one knob is advantageous at the two power supply lines of the filament. If the number of filament segments is N, in this case the number of knobs is consequently N+1. In the case of an incandescent filament with, for example, in total three filament segments, preferably in each case one knob is provided on the two filament supply lines and in each case one further knob is provided between the two connecting sections of the three segments, i.e. in total four knobs.

### BRIEF DESCRIPTION OF THE DRAWINGS

The invention will be explained in more detail below with reference to exemplary embodiments. In the figures:

FIG. 1 shows a plan view of a first exemplary embodiment of the lamp according to the invention,

FIG. 2 shows a longitudinal section rotated through 90° with respect to FIG. 1, and

FIG. 3 shows a longitudinal section illustration of a second exemplary embodiment of the lamp according to the invention.

### PREFERRED EMBODIMENT OF THE INVENTION

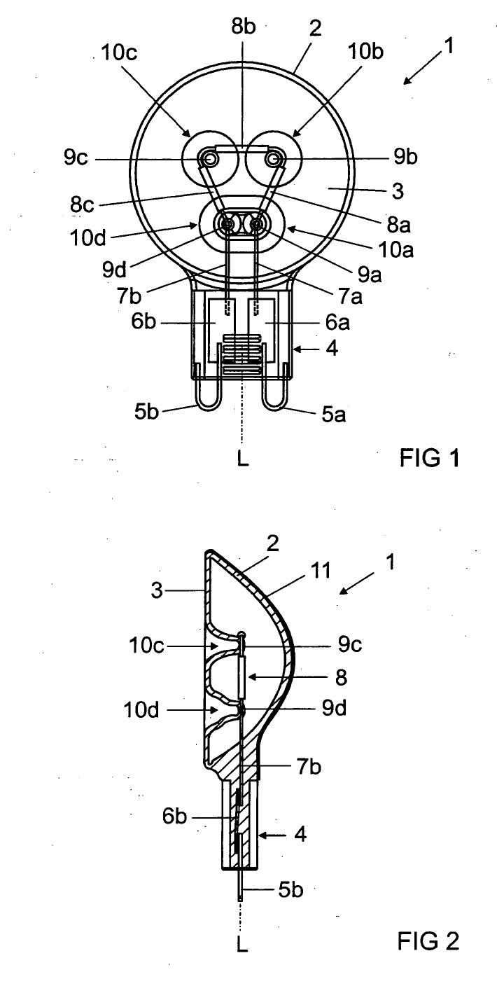

The text which follows refers to FIGS. 1 and 2, which schematically show a reflector lamp 1 according to the invention in a plan view and in a longitudinal section illustration rotated through 90° with respect thereto. The reflector lamp 1 has a bowl-shaped lamp vessel 2 made of quartz glass with a diameter of approximately 20 mm, whose end side is closed by a substantially planar end face 3. The end face does not necessarily need to be planar, as is shown in this exemplary embodiment, but can in principle also be slightly concavely or convexly curved. The lamp vessel 2 opens out into a glass base 4 of the type G9, i.e. for system voltage operation, which defines the lamp longitudinal axis L. In principle, however, other types of lamp base are also suitable. Two outer power supply lines 5a, 5b, which are bent in the form of a loop protrude out of the glass base 4. The total length of the reflector lamp 1, including the outer power supply lines 5a, 5b, is approximately 40 mm. In the interior of the glass base 4, two molybdenum foils 6a, 6b are sealed in in a gas-tight manner by means of pinch sealing. Said molybdenum foils are connected on one side to the outer power supply lines 5a, 5b and on the other side to the inner power supply lines 7a, 7b. The inner power supply lines 7a, 7b for their part end in an incandescent filament 8, which is used as a luminous element during lamp operation and has three filament segments 8a-8c. The three filament segments 8a-8c which incandesce during lamp operation are connected to one another via two uncoiled connecting sections and are arranged in the form of a diamond in a plane parallel to the lamp longitudinal axis L, the open side of the imaginary diamond opening out into the two inner power supply lines 7a, 7b. The incandescent filament 8 is connected to the tips 9a-9d of in total four knobs 10a-10d, which are turned in in the form of funnels from the end face 3 into the lamp vessel 2, at the two uncoiled connecting sections and the two connecting points between the incandescent filament 8 and the two inner power supply lines 7a, 7b. For this purpose, an uncoiled piece of filament wire section is fuse-sealed into the glass material of the corresponding knob tip 9a-9d at each of these mentioned four points. Owing to the physical vicinity of the two power supply lines 7a, 7b, the two knobs 10a, 10d overlap one another partially there. At the upper filament segment 8b, the two knobs 10b, 10c are completely separate from one another, on the other hand. In any case, the knobs 10a-10d extend substantially at right angles with respect to the lamp longitudinal axis A.

In order to form the knobs, initially the entire incandescent filament 8, including the inner power supply lines 7a, 7b connected thereto, is inserted into the lamp vessel 2 with the aid of a filament support (not illustrated) and is then fixed by means of the knobs 10a-10d. For this purpose, suitably shaped and heated mandrels (not illustrated) engage in the still soft glass material of the end face 3 of the lamp vessel 2 at right angles with respect to the lamp longitudinal axis L, given a correspondingly high local lamp vessel temperature, in such a way that the mentioned filament wire sections enter the still soft knob tips 9a-9d slightly, preferably by the incandescent filament being tentered, so to speak from the outside around the periphery, onto the knobs in order to achieve the required tensile force. In this case, the filament support also acts as an opposing bearing. Alternatively, the incandescent filament can also be connected to the knobs by other auxiliary means or by a form-fitting or force-fitting connection. Once the knobs 10a-10d are sufficiently hard by means of cooling, the filament support can be removed and the reflector lamp can be sealed in a gas-tight manner by means of conventional base pinch-sealing. This expediently takes place in a suitable pressure chamber. For the pinch-sealing of the base, the glass is heated by means of lasers, by the laser beam being injected into the pressure chamber through a suitable window. Before the pinch-sealing of the base, the filling gas is also introduced into the pressure chamber, which filling gas is consequently enclosed in the lamp vessel during the pinch-sealing of the base. As a result, it is not necessary for an exhaust tube to be attached and, consequently, after the latter has been closed, there is also no exhaust tip which disrupts the three-dimensional distribution of the light emitted through the end face 3. In principle, however, the lamp can alternatively also be manufactured in a conventional manner by means of an exhaust tube, for example without a pressure chamber. Finally, the cup-shaped section of the outside of the lamp vessel 2 is also provided with a light-reflecting metallic reflector layer 11. In this way, an extremely compact, laterally emitting reflector lamp for system voltage is achieved. One advantageous factor here is the fact that the reflector layer 11 remains completely smooth and therefore remains optically undisrupted, which favors the uniformity of the laterally emitted light distribution.

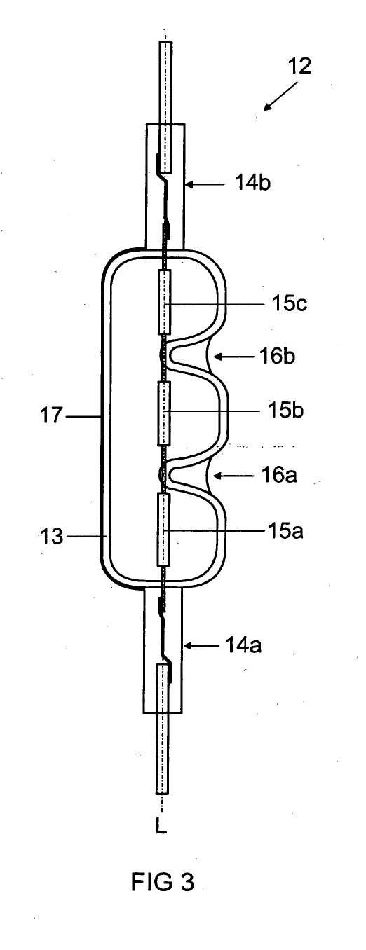

FIG. 3 shows a sectioned side view of a second exemplary embodiment. The lamp here is a double-ended lamp 12. Its substantially tubular lamp vessel 13 is sealed at both ends by means of pinch seals 14a, 14b. An incandescent filament with three filament segments 15a-15c is arranged axially within the lamp vessel 13. The two connecting sections between the three filament segments 15a-15c are held by means of in each case one knob 16a, 16b, in a similar manner to as in the first exemplary embodiment. The two knobs 16a, 16b are oriented radially with respect to the lamp longitudinal axis and are arranged in a common axial section plane. As a result, the outside of the lamp vessel 13 which is in the form of a half-shell and is opposite the two knobs 16a, 16b is completely smooth and is advantageously provided with a reflective layer 17.

1. An electric lamp (1) with
a lamp vessel (2),
at least one lamp base (4), which adjoins one end of the lamp vessel (2) and by means of which a lamp longitudinal axis (L) is defined,
at least one knob (10a-10d), which is formed by a turned-in portion of the lamp vessel (2) and extends substantially at right angles with respect to the lamp longitudinal axis L),
a luminous element (8), which is located within the lamp vessel, characterized in that
the luminous element (8) is held at least one holding point by precisely one knob (10a-10d).

2. The electric lamp as claimed in claim 1, the luminous element being arranged either axially or substantially in an imaginary plane, which is oriented parallel to the lamp longitudinal axis (L).

3. The electric lamp as claimed in claim 1 or 2, the turned-in portion, which forms the at least one knob (10a-10d), being in the form of a funnel.

4. The electric lamp as claimed in claim 1 a section of the luminous element (8) being embedded in the tip (9a-9d) of the knob at the at least one holding point.

5. The electric lamp as claimed in claim 1 the luminous element being formed by an incandescent filament (8).

6. The electric lamp as claimed in claim 5, the incandescent filament having, in the region of the at least one holding point, an auxiliary turn, which engages around the tip of the knob and firmly holds the incandescent filament in this way on the relevant knob.

7. The electric lamp as claimed in claim 1 with two or more holding points, precisely one knob being associated with each holding point.

8. The electric lamp as claimed in claim 7, knobs (10b, 10c; 10a, 10d) being separated completely from one another or partially overlapping one another.

9. The electric lamp as claimed in claim 7 or 8, the incandescent filament having filament segments with the number N, and the number of knobs in the case of a lamp (1) with a base at one end being N+1 and in the case of a lamp (12) with a base at both ends being N−1.

10. The electric lamp as claimed in claim 9, the incandescent filament being tentered in the form of an N+1-sided polygon, which is open on the side of the two power supply lines of the incandescent filament.

11. The electric lamp as claimed in claim 10, in each case one knob being provided in each case between two adjacent filament segments and in each case one knob being provided on the connection between the incandescent filament and the two power supply lines of the incandescent filament.

12. The electric lamp as claimed in claim 10, the incandescent filament being passed outwards under strain around the knobs, as a result of which the incandescent filament is equally tentered via the knobs.

13. The electric lamp as claimed in claim 1, the lamp vessel (2) having, parallel to the lamp longitudinal axis, a substantially flat or at least only slightly concavely or convexly curved section (3) and, opposite the latter, a section which is curved in the form of a cup.

14. The electric lamp as claimed in claim 13, the section which is curved in the form of a cup being provided with a reflective layer (11).

15. The electric lamp as claimed in claim 1, the lamp base (4) being formed from the material of the lamp vessel (2).

16. The electric lamp as claimed in claim 1, which is in the form of a halogen incandescent lamp for direct operation on the system voltage.
